(19) United States
(12) Patent Application Publication
(10) Pub. No.: US 2006/0261129 A1
(43) Pub. Date: Nov. 23, 2006

(54) Fastener driving device with adjustable handle

(75) Inventors: David M. McGee, Attleboro, MA (US); Charles W. Hewitt, Warwick, RI (US); Alexander J. Calvino, Cranston, RI (US); Prudencio S. Canlas JR., North Kingstown, RI (US)

Correspondence Address: PILLSBURY WINTHROP SHAW PITTMAN, LLP, P.O. BOX 10500, MCLEAN, VA, 22102, US

(73) Assignee: Stanley Fastening Systems, L.P., East Greenwich, RI (US)

(21) Appl. No.: 11/396,909

(22) Filed: Apr. 4, 2006

Related U.S. Application Data
(60) Provisional application No. 60/681,958, filed on May 18, 2005.

(51) Int. Cl. B25C 1/04

(52) U.S. Cl. 227/148; 227/130

(57) ABSTRACT

A fastener driving device for driving fasteners into flooring boards is disclosed. In an embodiment, the device includes a housing containing an engine for driving a fastener through a flooring board and into the sub-floor and a magazine for supplying a plurality of fasteners for the engine to drive. The device also includes a shoe that is configured to locate the engine relative to the flooring board so that the fastener is driven into the flooring board at an angle. The device further includes a handle that is slidingly received by the housing. The handle includes a grip for receiving a user's hand. A distance between the grip and the shoe is adjustable.

### CROSS-REFERENCE TO RELATED APPLICATIONS

The present application claims the benefit of priority from U.S. Provisional Patent Application No. 60/681,958, filed May 18, 2005 and entitled “FASTENER DRIVING DEVICE WITH ADJUSTABLE FEATURES,” the entire content of which is incorporated herein by reference.

### BACKGROUND OF THE INVENTION

1. Field of Invention

The present invention is generally directed to fastener driving devices. More specifically, the present invention is directed to a fastener driving device that includes an adjustable handle.

2. Description of Related Art

Typical pneumatic fastener driving devices utilize an integrated portion of the housing to serve as the “grip.” A particular sub-group of pneumatic fastener driving devices, commonly referred to as flooring tools, are used to drive either staples or cleats (nails) through tongue and groove flooring, generally composed of wood, and into a sub-floor, generally also composed of wood, thereby fixing the flooring to the sub-floor in a nearly rigid manner. The fasteners and the system of components used to drive the fasteners, generally referred to as the “engine,” should be placed in proximity to or often adjacent to the workpiece through which the fastener is intended to be driven.

Typically, the “grip” portion of the tool is in proximity to the “engine.” This design allows the user/operator of the tool to position the tool, and thus his hand in general proximity of the workpiece when desiring to drive a fastener. In the case of installing tongue and groove flooring, an operator positioning his hand in proximity of the workpiece, may, if standing, need to stoop dramatically in order to perform the work. Alternatively, an operator electing not to stand while performing this work may kneel, crouch or position himself in a generally uncomfortable manner for the duration of the time engaged in this work.

Manufacturers of pneumatic flooring tools, in an effort to mitigate the discomfort operators experience due to working in such positions for extended periods of time, have developed flooring tools that employ a grip that is rigidly attached to the tool through a resilient member which extends perpendicularly upward from the floor when the tool is correctly positioned with respect to the workpiece in order to drive a fastener. These grips generally allow the operator to stand in a more upright and comfortable position when performing the intended work. While most pneumatic flooring tools now employ such a grip in combination with an extended resilient member, a noted deficiency of these grips is that the position of the operator's hand is fixed with respect to the engine of the tool, and thus the workpiece, and is defined by the length of the extended resilient member. Further, each pneumatic tool manufacturer may determine a handle position that is unique to that manufacturer. These extended handles may serve only a very general improvement in position for the operator, but do not allow for operators of various heights, or preference in particular standing positions, to adjust the position of the handle.

### BRIEF SUMMARY OF THE INVENTION

It is an aspect of the present invention to provide a fastener driving device that can be used comfortably by users of different heights.

In an embodiment, a fastener driving device for fastening flooring boards to a sub-floor is provided. The device includes a housing containing an engine for driving a fastener through a flooring board and into the sub-floor, a magazine for supplying a plurality of fasteners for the engine to drive, a shoe configured to locate the engine relative to the flooring board so that the fastener is driven into the flooring board at an angle, and a handle that includes a grip for receiving a user's hand. The handle is configured to move along a substantially linear path relative to the housing to adjust a distance between the grip and the shoe.

In an embodiment, a fastener driving device for fastening flooring boards to a sub-floor is provided. The device includes a housing containing an engine for driving a fastener through a flooring board and into the sub-floor, and a magazine for supplying a plurality of fasteners for the engine to drive. The device also includes a shoe configured to locate the engine relative to the flooring board so that the fastener is driven into the flooring board at an angle. The device further includes a handle that is slidingly received by the housing. The handle includes a grip for receiving a user's hand. A distance between the grip and the shoe is adjustable.

Other aspects, features, and advantages of the present invention will become apparent from the following detailed description, the accompanying drawings, and the appended claims.

### BRIEF DESCRIPTION OF THE DRAWINGS

Features of the invention are shown in the drawings, in which like reference numerals designate like elements. The drawings form part of this original disclosure, in which:

FIG. 1 is a perspective view of an embodiment of a fastener driving device of the present invention with a handle in a retracted position;

FIG. 2 is a perspective view of the fastener driving device of FIG. 1 with the handle in an extended position;

FIG. 3 is another perspective view of the fastener driving device of FIG. 2;

FIG. 4 is a side view of a portion of the fastener driving device of FIG. 3 with the handle in the retracted position;

FIG. 5 is an opposite side view of the fastener driving device of FIG. 4;

FIG. 6 is a rear view of the fastener driving device of FIG. 4 with a handle lock in a locked position;

FIG. 7 is a view of Detail ‘A’ of FIG. 6;

FIG. 8 is a rear view of the fastener driving device of FIG. 6 with the handle lock in an unlocked position;

FIG. 9 is a view of Detail ‘B’ of FIG. 8;

FIG. 10 is a side view of the fastener driving device of FIG. 4 with the handle in the extended position;

FIG. 11 is an opposite side view of the fastener driving device of FIG. 10;

FIG. 12 is a rear view of the fastener driving device of FIG. 10, with the handle lock in the locked position;

FIG. 13 is a side view of another embodiment of a fastener driving device of the present invention with a handle in an extended position;

FIG. 14 is a side view of the fastener driving device of FIG. 13 with the handle in a retracted position;

FIG. 15 is a perspective view of the fastener driving device of FIG. 14 with the handle in a rotated position;

FIG. 16 is a side view of another embodiment of a fastener driving device of the present invention with a handle in a retracted position;

FIG. 17 is a side view of the fastener driving device of FIG. 16 with the handle in a fully extended position;

FIG. 18 is a side view of the fastener driving device of FIG. 16 with the handle in an intermediate position;

FIG. 19 is a cross-sectional view of a lock in a locked position for the handle taken along line 19-19 of FIG. 18;

FIG. 20 is a cross-sectional view of the lock of FIG. 19 in an unlocked position;

FIG. 21 is an opposite side view of the fastener driving device of FIG. 18 with the lock in the locked position;

FIG. 22 is a cross-sectional view taken along line 22-22 of FIG. 21;

FIG. 23 is a view of Detail ‘C’ of FIG. 22; and

FIG. 24 is a view of FIG. 23 with the lock in the unlocked position.

### DETAILED DESCRIPTION OF THE INVENTION

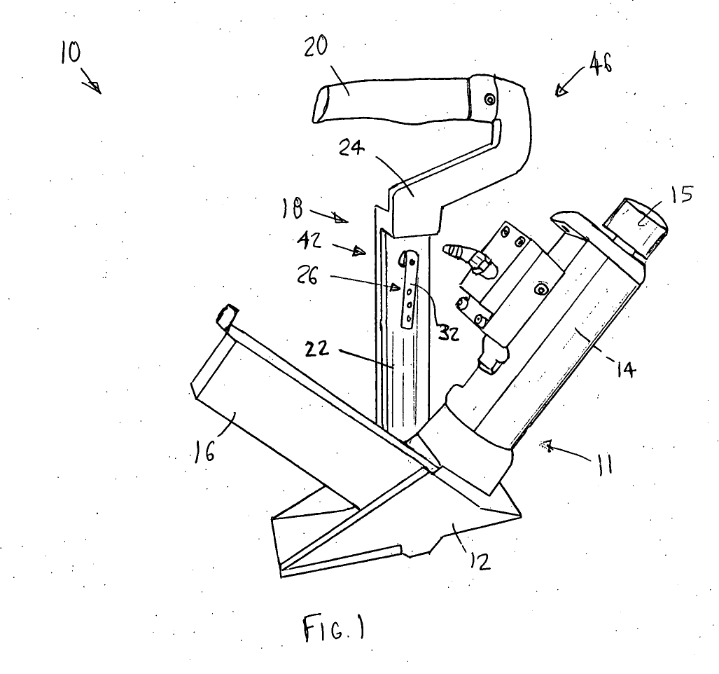

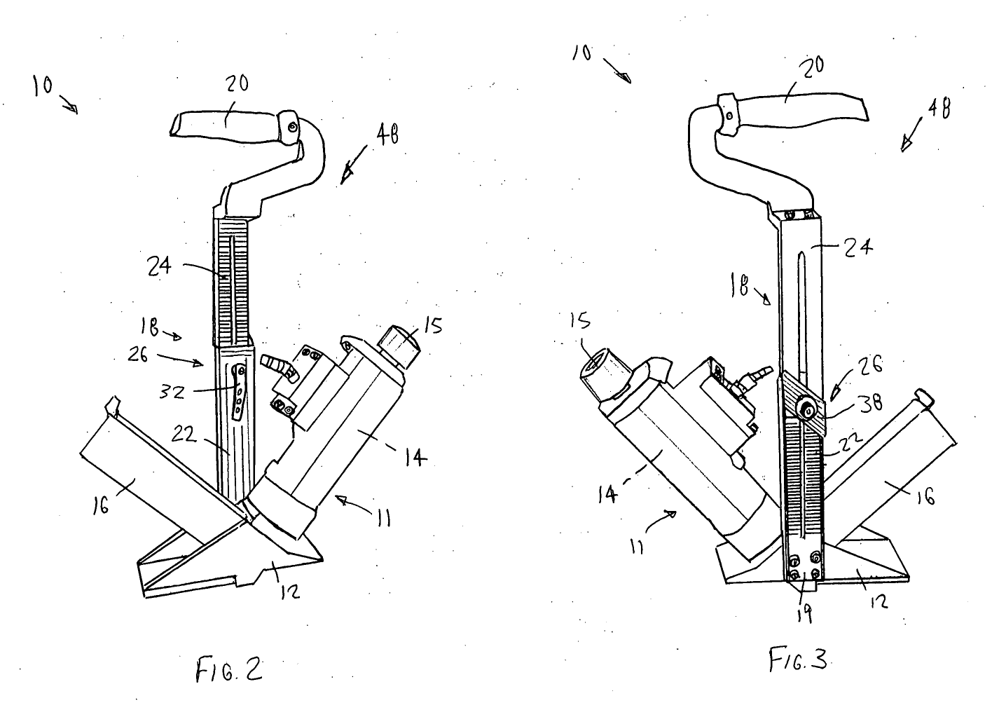

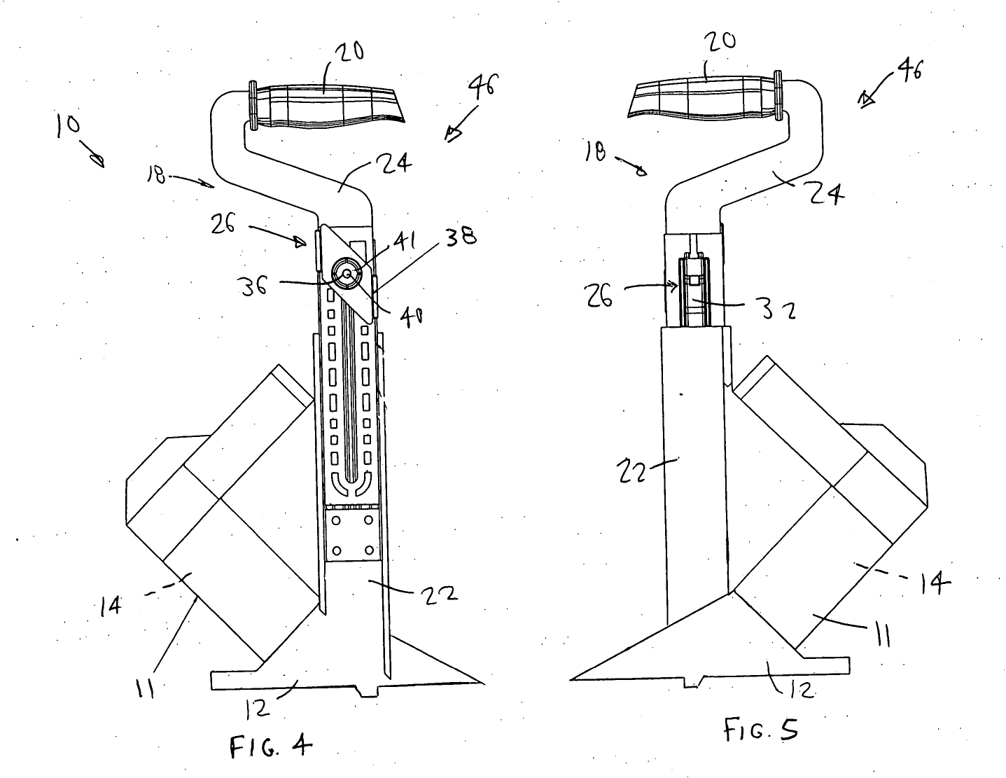

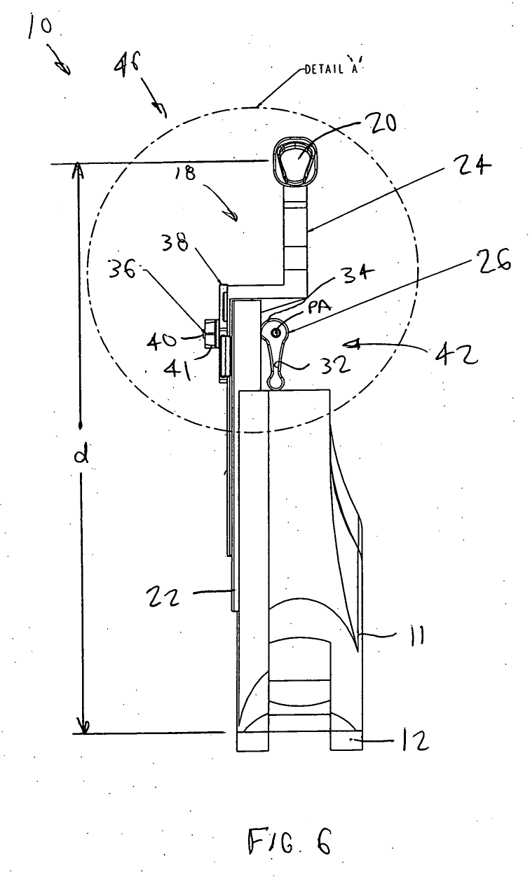

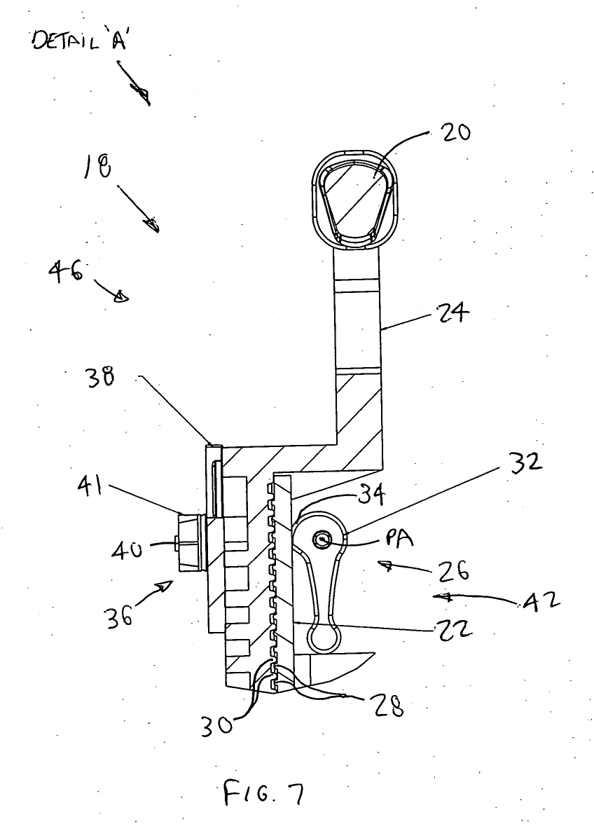

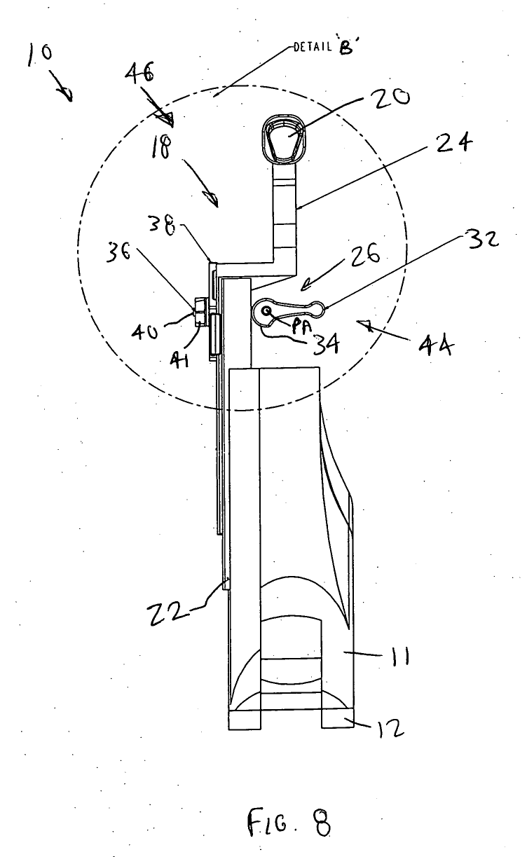

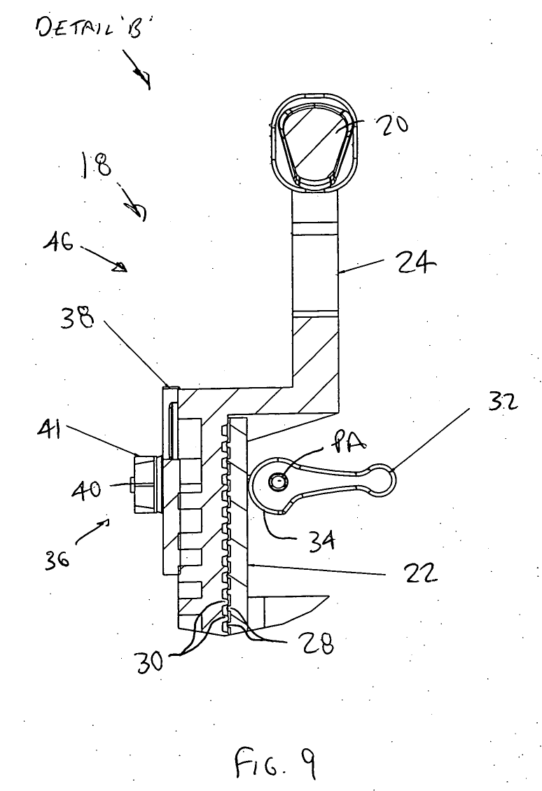

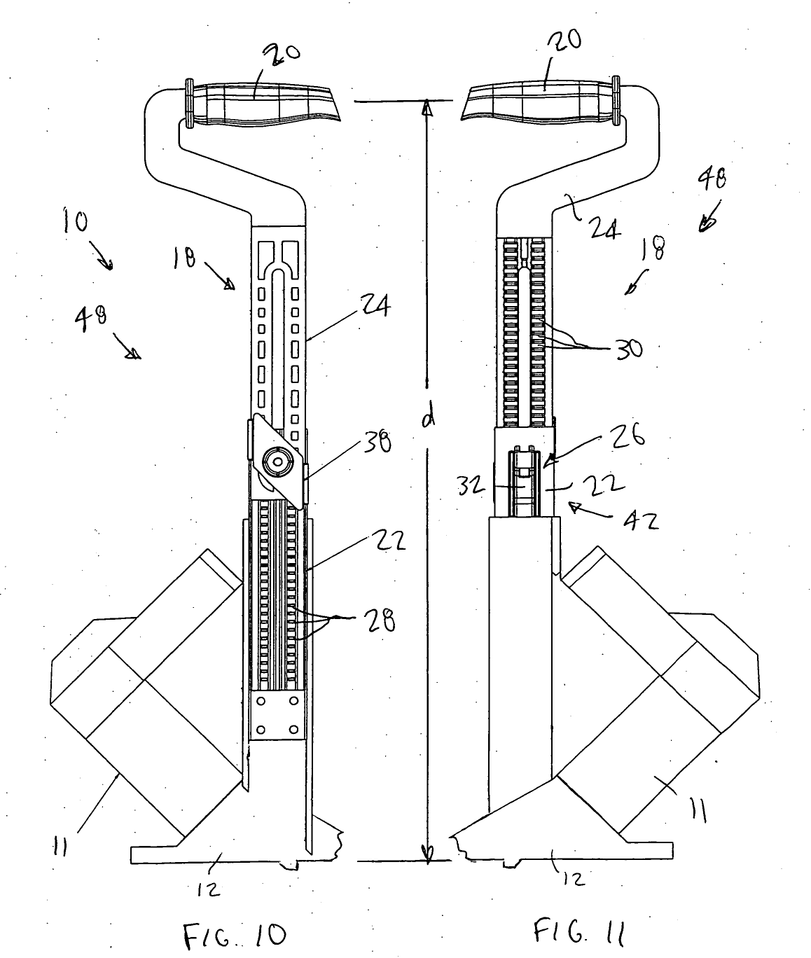

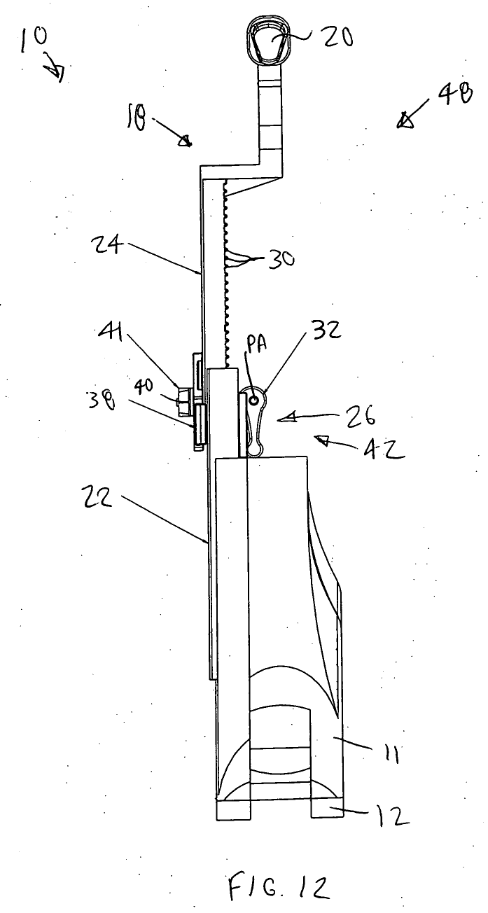

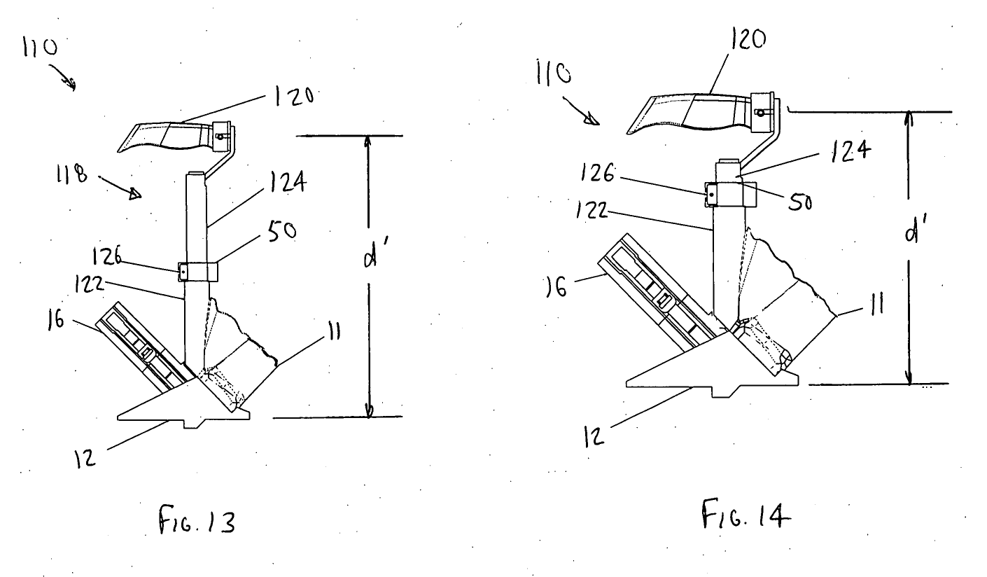

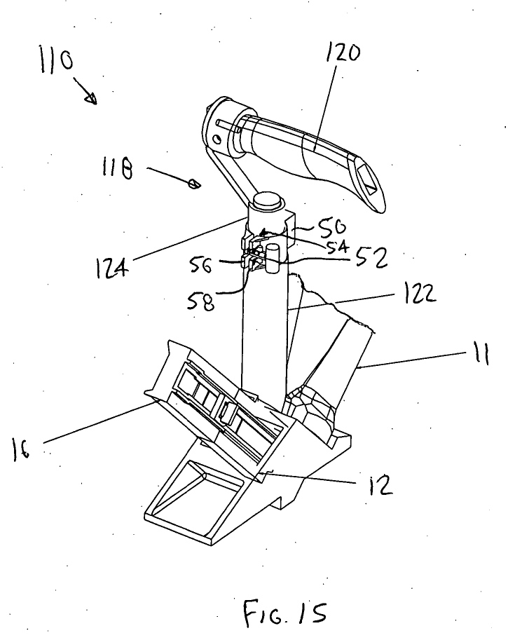

A fastener driving device 10 for fastening flooring boards to a sub-floor in accordance with an embodiment of the invention is shown in FIG. 1. The device 10 includes a housing 11, a shoe 12 connected to the housing 11, an engine 14 contained within the housing 11, a nose connected to the housing 11 through which fasteners are driven, a magazine 16 that is connected to the nose, and a handle 18 that is connected to the housing 11 at one end 19 thereof. The device 10 may also be referred to as a tool, a nailer, a flooring tool, or a flooring nailer. The shoe 12 is generally configured to rest on a top surface of at least one flooring board so that a fastener may be driven through the flooring board by the engine 14 at an angle, and into a sub-floor.

The engine 14 may be of any type of engine 14 that is used in flooring nailers. For example, the engine 14 may be of a manually actuated type that converts energy provided by the user into energy that drives the fastener. Such engines 14 are described in, for example, U.S. Pat. No. 3,281,046, which is incorporated herein by reference. The engine 14 may also be of a pneumatic type that uses compressed gas, such as air, to power the engine 14 to drive the fastener upon actuation of an actuator 15, such as the actuator shown in FIG. 1. An example of a pneumatic engine for a flooring tool is described in, for example, U.S. Pat. No. 3,542,273, which is incorporated herein by reference. Because the specific internal design of the engine 14 is not related to the features of the present invention, the internal design of the engine 14 is not discussed further.

The magazine 16 may include a spring biased pusher that is configured to supply a plurality of fasteners to the nose so that the engine 14 may drive the fasteners, one by one, into the flooring board. The fasteners may be staples, cleats, wire nails, or any other type of fastener that may be used to secure the flooring board to the sub-floor.

The handle 18 includes a grip 20 at an end that is opposite the end 19 that is connected to the housing 11. In an embodiment, the end 19 of the handle 18 is connected to housing 11 via the shoe 12, i.e., the handle 18 is attached to the shoe 12, which is attached to the housing 11. The grip 20 is configured to be grasped by a user's hand. The grip 20 may be of any shape, but is preferably shaped so that it is relatively easy for a person to firmly grasp and hold the device 10. The grip 20 may be molded from plastic or rubber and may be attached to the handle 18 with fasteners 21, such as screws. Alternatively, the grip 20 may be press fit or even insert molded onto a portion of the handle. It is also contemplated that the grip 20 may be an integral part of the handle 18. The illustrated embodiments should not be considered to be limiting in any way.

As shown in the Figures, the handle 18 also includes a fixed portion 22 and a movable portion 24 that is movable relative to the fixed portion 22. In the embodiments shown, the fixed portion 22 includes the end 19 of the handle 18 that is attached to a portion of the shoe 12, and the movable portion 24 includes the grip 20. This allows a distance d between the grip 20 and a portion of the shoe 12 that sits on the flooring board to be adjusted so that the user may select the height of the grip 20 relative to the flooring board, thereby improving the comfort of the user when using the device 10. In an embodiment, the movable portion 24 of the handle 18 is configured to move along a substantially linear path relative to the housing 11 to adjust the distance d between the grip 20 and the shoe 12. The handle 18 also includes a lock 26 that locks the position of the movable portion 24 relative to the fixed portion 22.

In the embodiments shown in the FIGS. 1-12, the fixed portion 22 includes a plurality of teeth 28 and the movable portion 24 includes a plurality of teeth 30 that are constructed and arranged to interlock with the plurality of teeth 28 on the fixed portion 22. Such an arrangement allows the handle 18 to be “indexed” to different positions, thereby varying the distance d between the grip 20 and the shoe 12.

As shown in FIGS. 6-9, the lock 26 includes a lever 32 with a cam surface 34 that rotates about a pivot axis PA. The pivot axis PA passes through a longitudinal axis of a fastener 36 that fastens the lever 32 to a clamp plate 38 that is disposed on an opposite side of the fixed portion 24 and the movable portion 22 of the handle 18, as shown FIGS. 6-9. The fastener 36 may be, but is not limited to a bolt 40 and a nut 41. As discussed below, the clamp plate 38 and the lever 32, via the cam surface 34, provide compression therebetween, which presses the fixed portion 22 and the movable portion 24 of the handle 18 towards one another.

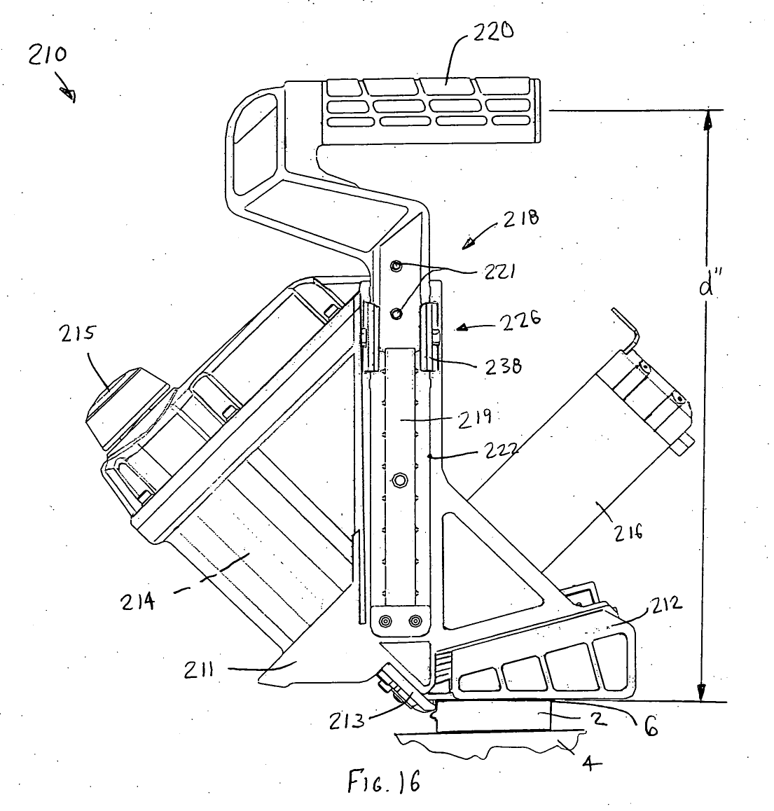

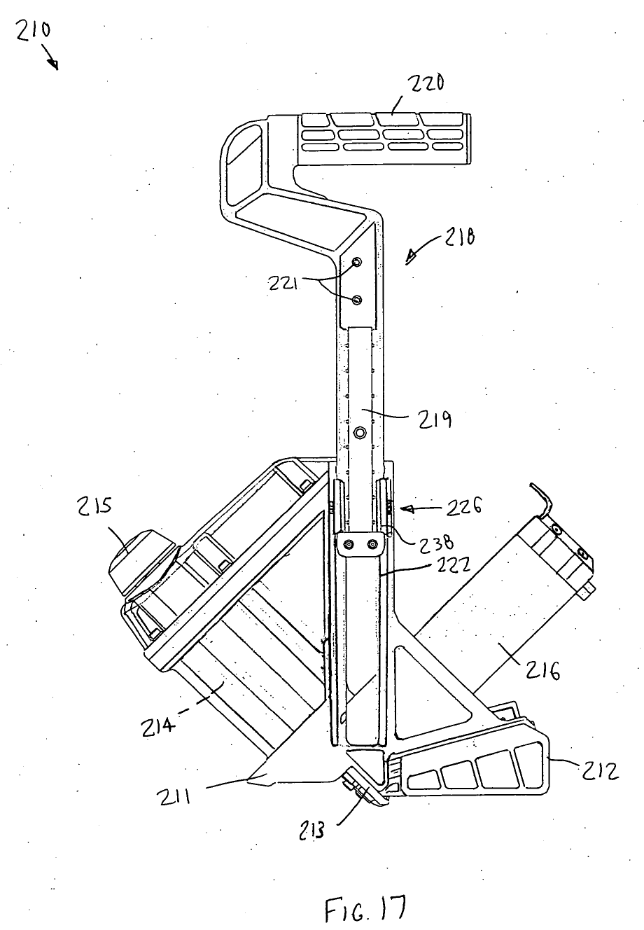

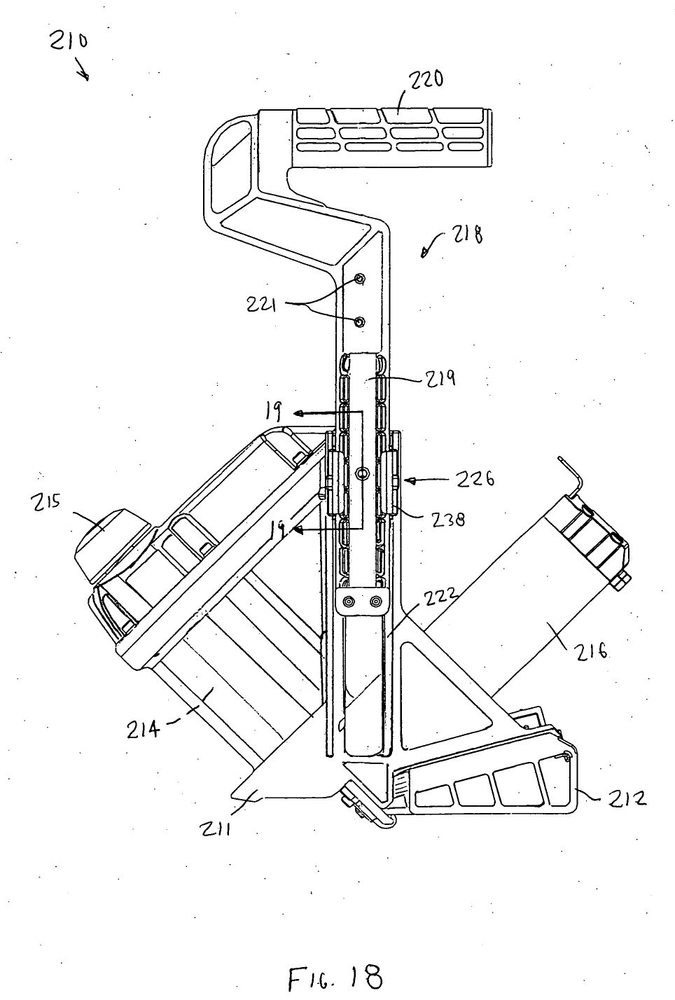

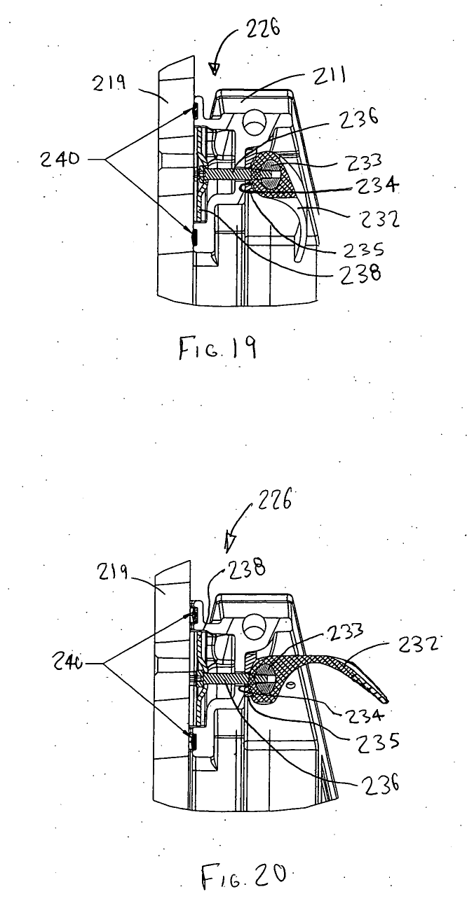

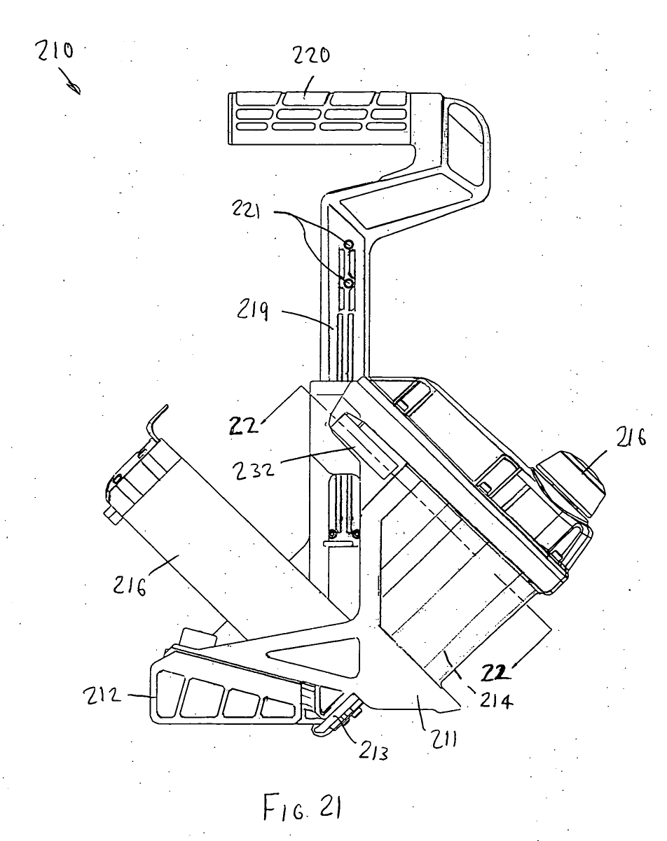

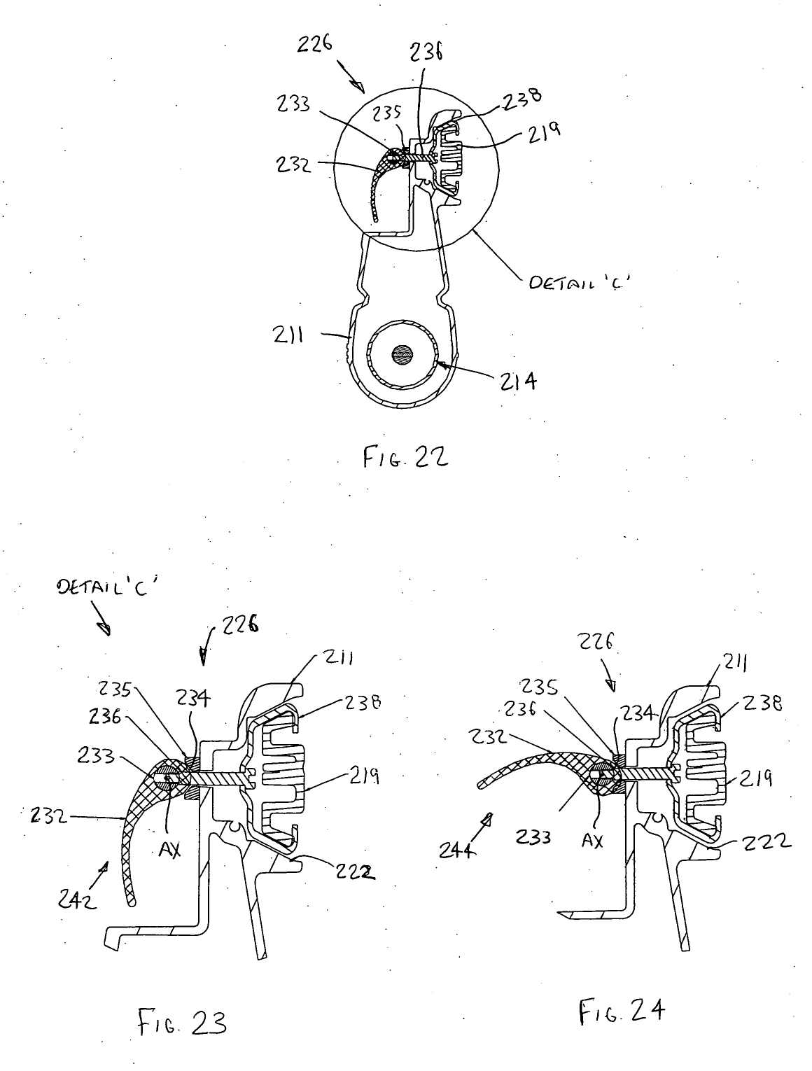

Due to the eccentricity of the cam surface 34 relative to the pivot axis PA, rotation of the lever 32 repositions the cam surface 34 so that when the lever 32 is in a locked position 42, as shown in FIGS. 6 and 7, a portion of the cam surface 34 engages the fixed portion 22 of the handle 18 so that the lever 32 presses against the fixed portion 22 so that the lever 32 and the clamp plate 38 compress the fixed portion 22 and the movable portion 24. This causes the plurality of teeth 28 on the fixed portion 22 to engage the plurality of teeth 30 on the movable portion 24, thereby locking the position of the movable portion 24 relative to the fixed portion 22. Rotation of the lever 32 to an unlocked position 44, as shown in FIGS. 8 and 9, relieves the compression provided by the cam surface 34 and the clamp plate 38, thereby allowing the teeth 28 on the fixed portion 22 to disengage from the teeth 30 on the movable portion 24. This allows the movable portion 24 to move relative to the fixed portion 22, such as from a retracted position 46, shown in FIGS. 1, 4-9, to an extended position 48, shown in FIGS. 2, 3, and 10-12. The fastener 36 may be adjusted to change the compression between the clamp plate 38 and the lever 32, thereby making it more or less difficult to adjust the handle 18.

FIGS. 13-15 illustrate another embodiment of a fastener driving device 110 of the present invention. The device 110 includes the housing 11, the shoe 12, the engine 14, and the magazine 16 as described above. The device 110 also includes a handle 118 that includes an end 119 connected to the shoe 12 and a grip 120 at an end opposite the end 119 that is connected to the shoe 12. The grip 120 may be configured like the grip 20 of the embodiment shown in FIGS. 1-12.

The handle 118 also includes a fixed portion 122 and a movable portion 124 that is movable relative to the fixed portion 122. In the embodiments shown, the fixed portion 122 includes the end 119 of the handle 118 that is attached to the shoe 12, and the movable portion 124 includes the grip 120. The fixed portion 122 and the movable portion 124 have substantially circular cross-sections, with the movable portion 124 being received by the fixed portion 122 due to the relative sizes of the portions 122, 124. Of course, the cross-sections may be of any shape, so long as the movable portion 124 or the fixed portion 122 may be received by the other portion 122, 124, thereby providing a telescoping relation between the two portions 122, 124 of the handle 118. This allows a distance d′ between the grip 120 and the shoe 12 to be adjusted so that the user may select the height of the grip 120, thereby improving the comfort of the user when using the device 110. The handle 118 also includes a lock 126 that locks the position of the movable portion 124 relative to the fixed portion 122.

As shown in FIG. 15, the lock 126 includes a clinching collar 50 and a latching mechanism 52. The collar 50 may be disposed so that it substantially surrounds the fixed portion 122, but is open on one side 54. The latching mechanism 52 may be connected to the collar 50 at the open side 54 such that it pulls opposing ends 56, 58 of the collar 50 toward each other, thereby providing pressure to the periphery of the fixed portion 122. In other words, the latching mechanism 52 may be constructed to influence the collar 50 to vary its inside diameter. Because the collar 50 substantially surrounds the fixed portion 122 of the handle 118, the adjustment of the inside diameter of the collar 50 is transferred to a discrete section of the fixed portion 122.

When the latching mechanism 52 is positioned so as to allow the collar 50 to have an unrestricted or open diameter, the corresponding diameter of the adjacent section of the fixed portion 122 is allowed to achieve its nominal dimension, thereby allowing the movable portion 124 of the handle 118 to be moved freely within the fixed portion 122. When the latching mechanism 52 is positioned such that the collar 50 is constricted and thus has a reduced inside diameter, the diameter of the corresponding, discrete section of the fixed portion 122 is also reduced. This reduced diameter of the section of the fixed portion 122 forces the inside diameter wall to interfere with the adjacent outside diameter of the movable portion 124. The friction resulting from this interference between the fixed portion 122 and the movable portion 124 arrests the motion of the components relative to each other, thereby fixing the position of the grip 120.

Of course, other arrangements of a latching mechanism may be used. For example, the latching mechanism 52 may include a fastener that is received by threaded portions the ends 56, 58 of the collar 50 so that the fastener may be tighten, thereby pulling the ends 56, 58 of the collar 50 toward each other. The illustrated embodiment should not be considered to be limiting in any way. As shown in FIG. 15, because the movable portion 124 may be rotated relative to the fixed portion 122, the orientation of the grip 120 may also be adjusted.

FIGS. 16-24 illustrate another embodiment of a fastener driving device 210 of the present invention. The device 210 includes a housing, or frame, 211, a shoe 212 connected to the housing 211, an engine 214 contained within the housing 211, a nose 213 connected to the housing 211 through which fasteners are driven, a magazine 216 that is connected to the nose 213, and a handle 218 that is slidingly received by the housing 211. The device 210 may also be referred to as a tool, a nailer, a flooring tool, or a flooring nailer. The housing 211 as defined herein broadly refers to any structural portion that defines the shape and configuration of the tool. The shoe 212 is generally configured to rest on a top surface 6 of at least one flooring board 2 so that a fastener may be driven through the flooring board 2 by the engine 214 at an angle, and into a sub-floor 4.

The engine 214, like the engine 14 discussed above, may be of any type of engine that is used in flooring nailers. For example, the engine 214 may be of a manually actuated type that converts energy provided by the user into energy that drives the fastener, as described above. The engine 214 may also be of a pneumatic type that uses compressed gas, such as air, to power the engine 214 to drive the fastener upon actuation of an actuator 215, such as the actuator shown in FIG. 16. An engine of this type is discussed above. Because the specific internal design of the engine 214 is not related to the features of the present invention, the internal design of the engine 214 is not discussed further.

The magazine 216 may include a spring biased pusher that is configured to supply a plurality of fasteners to the nose 213 so that the engine 214 may drive the fasteners, one by one, into the flooring board 2. The fasteners may be staples, cleats, wire nails, or any other type of fastener that may be used to secure the flooring board 2 to the sub-floor 4.

The handle 218 includes a stalk 219 and a grip 220 at one end of the stalk 219. The grip 220 is configured to be grasped by a user's hand. The grip 220 may be of any shape, but is preferably shaped so that it is relatively easy for a person to firmly grasp and hold the device 210. The grip 220 may be molded from plastic or rubber and may be attached to the stalk 219 with fasteners 221, such as screws. Alternatively, the grip 220 may be press fit or even insert molded onto a portion of the handle 218. It is also contemplated that the grip 220 may be an integral part of the handle 218. The illustrated embodiment should not be considered to be limiting in any way.

As shown in FIGS. 16 and 17, the housing 211 includes a track 222 that is configured to receive the stalk 219 such that the handle 218 is movable relative to the housing 211. This allows a distance d″ between the grip 220 and a bottom surface 224 portion of the shoe 212 that sits on the flooring board 2 to be adjusted so that the user may select the height of the grip 220 relative to the flooring board 2, thereby improving the comfort of the user when using the device 210. In an embodiment, the handle 218 is configured to move along a substantially linear path relative to the housing 211 to adjust the distance d″ between the grip 220 and the shoe 212.

The device 210 also includes a lock 226 that locks the position of the handle 218 relative to the housing 211. As shown in FIGS. 19, 20, 23, and 24, the lock 226 includes a lever 232 with a cam surface 234. The lever 232 is configured to be engaged by the user and rotated about a pivot axis AX. The cam surface 234 is eccentric with the pivot axis AX, as will be discussed in greater detail below. The lever 232 also includes a pivot barrel 233 contained therein. The pivot axis AX passes through a center of the pivot barrel 233. A fastener 236 fastens a clamp 238 that is disposed on an opposite side of the housing 211 as the lever 232 to the lever 232 via the pivot barrel 233. That is, the fastener 236 screws into the pivot barrel 233 in such a way to allow the lever 232 to pivot relative to the fastener 236 via the pivot barrel 233. A longitudinal axis of the fastener 236 preferably intersects the pivot axis AX substantially perpendicularly. This arrangement allows lamping of the stalk 219 when the clamp 238 is moved toward the housing 211. With this configuration, the pivot barrel 233 stays in a fixed position, while the lever 232 is able to pivot relative to the pivot barrel 233. A washer 235 is disposed between the cam surface 234 of the lever 232 and the housing 211, as shown in the Figures.

The housing 211 also includes at least one gripper 240, shown in FIGS. 19 and 20, that is configured to engage the stalk 219 of the handle 218 when the handle 218 is clamped against the housing 211. A pair of grippers 240 are shown in the Figures, although the illustrated embodiment should not be considered to be limiting in any way. The grippers 240 provide a frictional surface that prevents the handle 218 from moving relative to the housing 211, without the use of significant force, when the lever 232 is in the locked position and the handle 218 is clamped against the housing 211. Of course, it is contemplated that the grippers 240 could be disposed on the stalk 219 of the handle 218 such that they engage the housing 211 when the lever 232 is in the locked position. The illustrated embodiment should not be considered to be limiting in any way.

As shown in greater detail in FIGS. 23 and 24, the clamp 238 is configured to at least partially surround the stalk 219. The clamp 238 and the lever 232 provide compression between the clamp 238 and the housing 211 when the lever 232 is in a locked position, thereby clamping the stalk 219 of the handle 218 against the housing 211. This locks the handle 218 to the housing 211 such that the handle 218 cannot be moved relative to the housing 211 without significant force.

Rotation of the lever 232 repositions the cam surface 234 so that when the lever 232 is in a locked position 242, as shown in FIG. 23, a portion of the cam surface 234 that is farthest away from the pivot axis AX engages the washer 235, thereby forcing the fastener 236 to move towards the housing 211 such that the lever 232, the housing 211, and the clamp 238 work together to clamp the stalk 219 in the track 222 of the housing 211. In this position, as shown in FIG. 19, the grippers 240 on the housing 211 to engage the stalk 219, thereby locking the position of the handle 218 relative to the housing 211

As shown in FIG. 24, when the lever 232 is rotated to an unlocked position 244, a portion of the cam surface 234 that is closer to the pivot axis AX, due to the eccentricity of the cam surface 234 relative to the pivot axis AX, engages the washer 235, thereby allowing the fastener 236, and hence clamp 238, to move away from the lever 232. This movement relieves the clamping pressure from the stalk 219. As shown in FIG. 20, when the lever 232 is in this position, the grippers 240 no longer engage the stalk 219, so that the handle 218 can be moved relative to the housing 211 within the track 222 with relative ease. Similar to a previously described embodiment, the fastener 236 may be adjusted to change the compression between the clamp 238 and the lever 232, thereby making it more or less difficult to move the lever 232 between the locked 242 and the unlocked 244 positions.

It is also contemplated that in this embodiment, like the embodiment discussed above, the handle 218 may include a plurality of teeth that are constructed and arranged to engage and interlock with a plurality of teeth on the housing 211. As described above, such an arrangement allows the handle 218 to be “indexed” to different positions.

In use, if the user would like to change the position of the grip 220 relative to the flooring surface 6, the user may simply grasp the lever 232 of the lock 224 and move the lever 232 in a direction away from the housing 211 to the unlocked position (as shown in FIGS. 20 and 24). The handle 218 is now free to slide within the track 222 relative to the housing 211. When the grip 220 is in the desired position, the user may move the lever 232 in a direction toward the housing 211 to the locked position (as shown in FIGS. 19 and 22), which locks the handle 218 in place.

All of the various features and mechanisms described with respect to the specific embodiments may be interchanged with the various embodiments described, or may be used with other variations or embodiments.

The foregoing illustrated embodiments have been provided solely for illustrating the structural and functional principles of the present invention and are not intended to be limiting. To the contrary, the present invention is intended to encompass all modifications, alterations, substitutions, and equivalents within the spirit and scope of the following claims.

What is claimed is:

1. A fastener driving device for fastening flooring boards to a sub-floor, the device comprising:
a housing containing an engine for driving a fastener through a flooring board and into the sub-floor;
a magazine for supplying a plurality of fasteners for the engine to drive;
a shoe configured to locate the engine relative to the flooring board so that the fastener is driven into the flooring board at an angle; and
a handle comprising a grip for receiving a user's hand, the handle being configured to move along a substantially linear path relative to the housing to adjust a distance between the grip and the shoe.

2. A fastener driving device according to claim 1, wherein the handle further comprises a fixed portion that is connected to the housing, and a movable portion that is movable substantially linearly relative to the fixed portion to adjust the distance between the grip and the shoe.

3. A fastener driving device according to claim 2, wherein the movable portion comprises a plurality of teeth that are configured to engage a plurality of teeth on the fixed portion so that the distance between the grip and the shoe may be indexed.

4. A fastener driving device according to claim 3, further comprising a lock that locks engagement of the teeth of the fixed portion with the teeth of the movable portion.

5. A fastener driving device according to claim 4, wherein the lock comprises a lever having a cam surface, the lever being connected to the fixed portion of the handle and rotatable relative to the fixed portion, wherein the cam surface presses against the fixed portion, thereby locking the engagement of the teeth of the fixed portion with the teeth of the movable portion when the lock is in a locked position.

6. A fastener driving device according to claim 5, wherein when the lock is in an unlocked position, the cam surface does not press against the fixed portion, thereby allowing disengagement of the teeth of the fixed portion from the teeth of the movable portion.

7. A fastener driving device according to claim 2, wherein the movable portion is received by an interior of the fixed portion.

8. A fastener driving device according to claim 7, further comprising a lock that locks a position of the movable portion relative to the fixed portion.

9. A fastener driving device according to claim 8, wherein the lock comprises a collar that substantially surrounds the handle, and a latching device for varying pressure applied by the collar to the handle so that the movable portion is fixed relative to the fixed portion when the pressure is increased above a threshold and the movable portion is movable relative to the fixed portion when the pressure is decreased below the threshold.

10. A fastener driving device according to claim 1, wherein the engine is manually actuated and converts energy provided by the user into energy that drives the fastener.

11. A fastener driving device according to claim 1, wherein the engine is a pneumatic engine that uses a compressed gas to power the engine.

12. A fastener driving device according to claim 1, wherein the shoe is mounted to the housing.

13. A fastener driving device according to claim 12, wherein the handle is mounted to the shoe at said one end.

14. A fastener driving device for fastening flooring boards to a sub-floor, the device comprising:
a housing containing an engine for driving a fastener through a flooring board and into the sub-floor;
a magazine for supplying a plurality of fasteners for the engine to drive;
a shoe configured to locate the engine relative to the flooring board so that the fastener is driven into the flooring board at an angle; and
a handle slidingly received by the housing, the handle comprising a grip for receiving a user's hand,
wherein a distance between the grip and the shoe is adjustable.

15. A fastener driving device according to claim 14, wherein the shoe is mounted to the housing.

16. A fastener driving device according to claim 14, wherein the housing defines a track that receives the handle.

17. A fastener driving device according to claim 16, wherein the handle is configured to move substantially linearly relative within the track relative to the housing to adjust the distance between the grip and the shoe.

18. A fastener driving device according to claim 16, further comprising a lock constructed and arranged to lock the handle relative to the housing.

19. A fastener driving device according to claim 18, wherein the lock comprises a clamp for clamping the handle against the housing.

20. A fastener driving device according to claim 19, wherein the lock further comprises a lever connected to the clamp, the lever being pivotable relative to the clamp, wherein when the lever is pivoted in a first direction, the clamp clamps the handle against the housing, and wherein when the lever is pivoted in a second direction, the clamp releases the handle so that the handle may move relative to the housing.

21. A fastener driving device according to claim 20, wherein the lock further comprises at least one gripper disposed between the housing and the handle, the gripper providing a frictional surface that prevents the handle from moving relative to the housing when the handle is clamped against the housing.

22. A fastener driving device according to claim 21, wherein the gripper is attached to the housing.

23. A fastener driving device according to claim 20, wherein the handle comprises a first plurality of teeth and the housing comprises a second plurality of teeth, the first plurality of teeth being configured to engage the second plurality of teeth to prevent the handle from moving relative to the housing when the handle is clamped against the housing.

24. A fastener driving device according to claim 14, wherein the engine is manually actuated and converts energy provided by the user into energy that drives the fastener.

25. A fastener driving device according to claim 14, wherein the engine is a pneumatic engine that uses a compressed gas to power the engine.
